(19) United States
(12) Patent Application Publication
(10) Pub. No.: US 2013/0035955 A1
(43) Pub. Date: Feb. 7, 2013

(54) Method and System to deliver state of the art concierge medical services to healh care consumers via a control center and a network of mobile medical platforms

(71) Applicant: Adam Torres, Piermont, NY (US)

(72) Inventor: Adam Torres, Piermont, NY (US)

(21) Appl. No.: 13/195,179

(22) Filed: Aug. 1, 2011

(51) Int. Cl. G06Q 50/00; G06F 1/26

(52) U.S. Cl. 705/3; 705/2; 713/300

(57) ABSTRACT

The method and system regard a medical concierge service combining a control center with a network of mobile medical platforms incorporating onsite and remote medical professionals, advanced medical, internet, videoconferencing, satellite, communication, computing, digital devices, electronic heath record and clean energy technologies to deliver state of the art medical services to patients at their chosen appointment time and location. The method and system increases access to healthcare, reduces associated costs and enhances traditional medical services while creating a here to unknown way of providing patient healthcare.

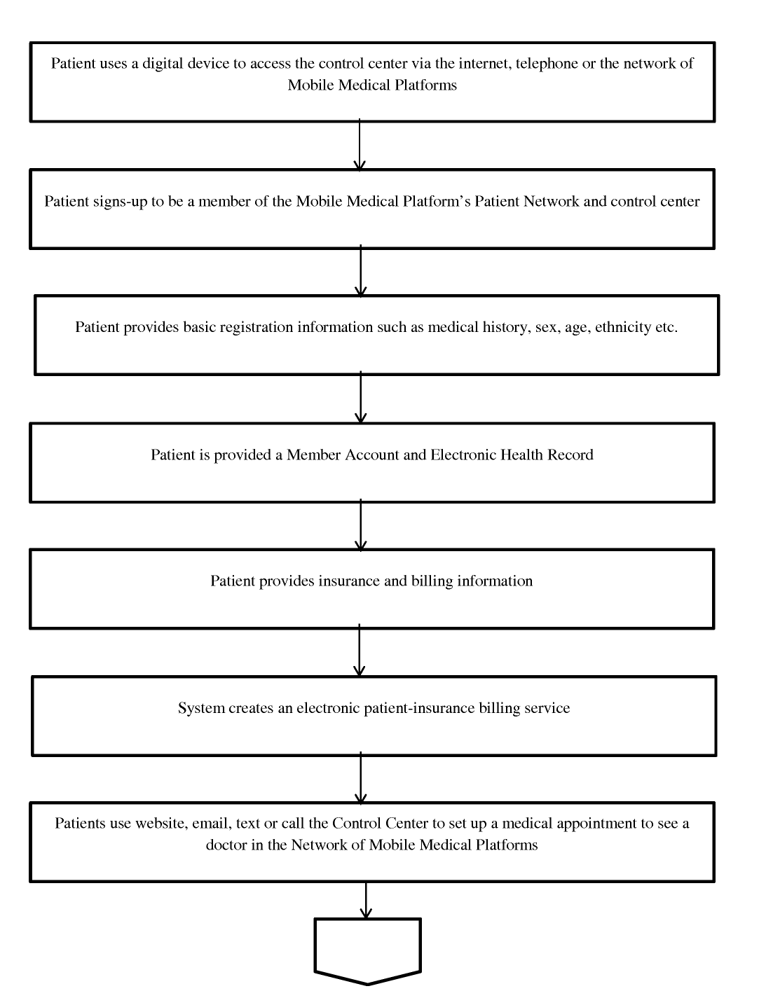

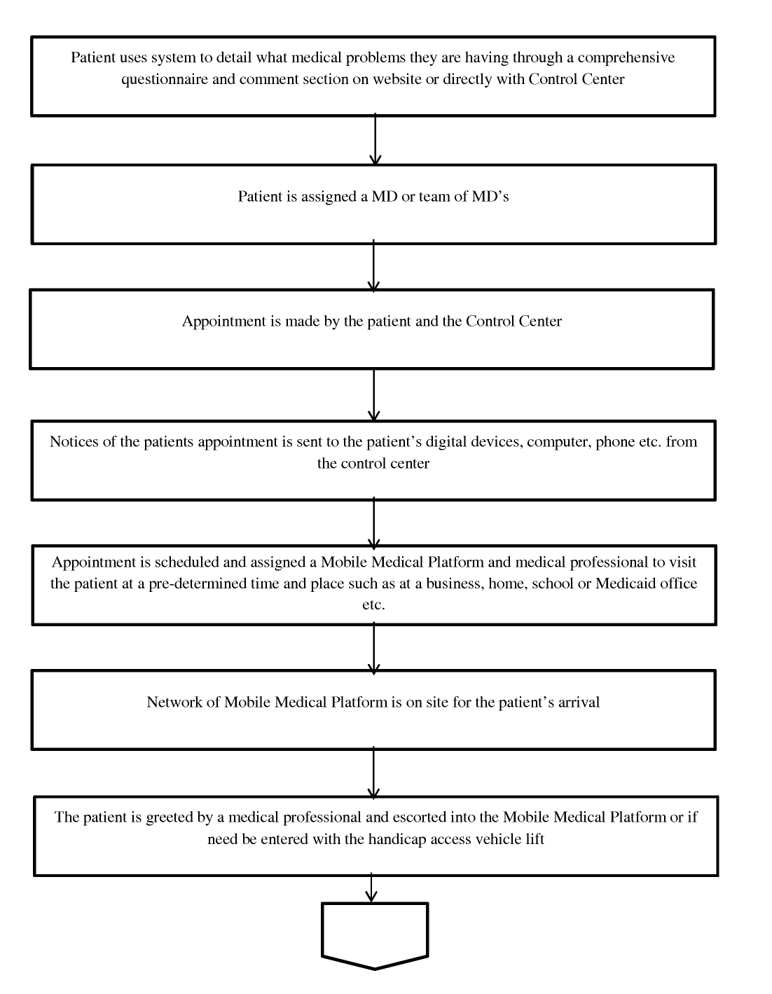

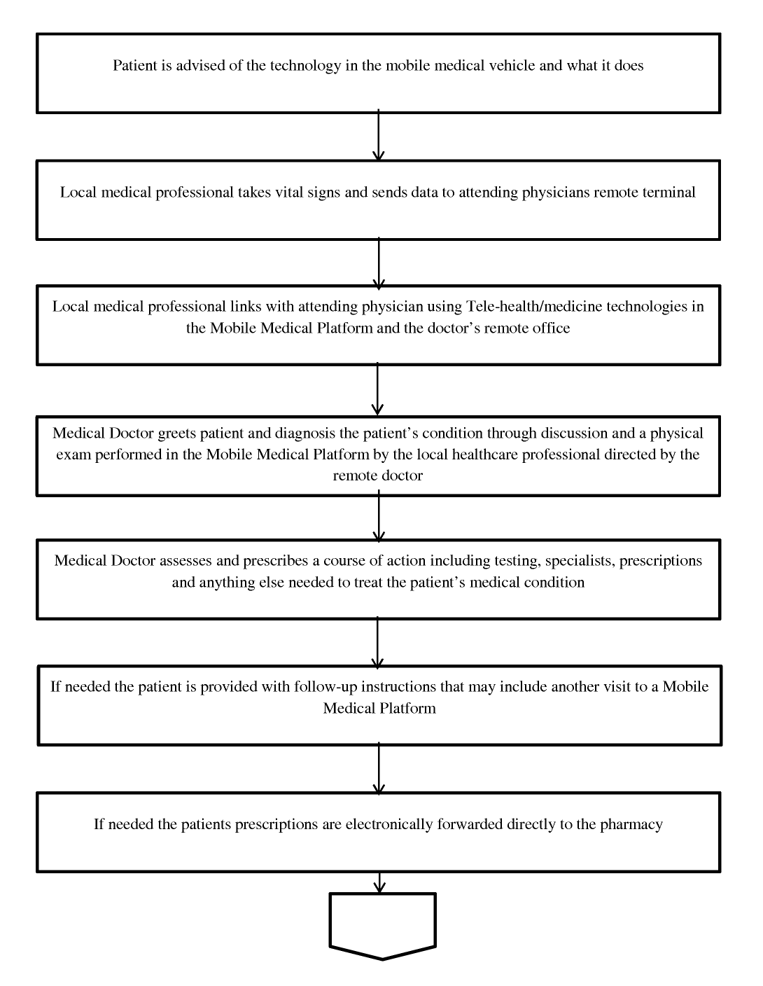

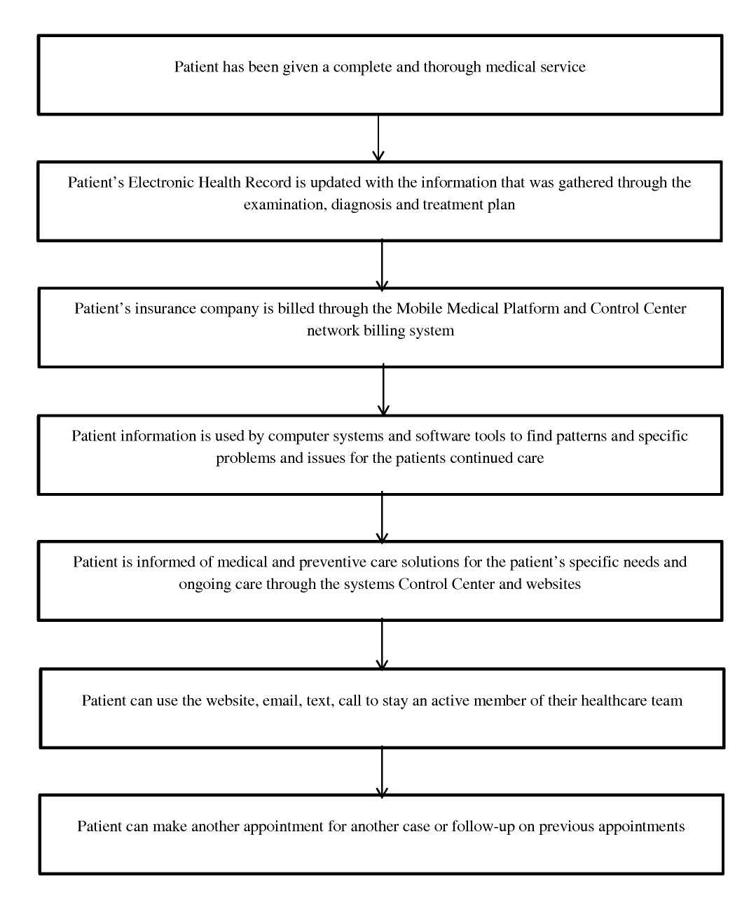

### CROSS REFERENCE TO RELATED APPLICATIONS

None

### BACKGROUND

1. Field of Invention

The method and system regards medical procedures and platforms, telemedicine/health systems and patient services

2. Description of Related Art

Any discussion of the prior art throughout the specification should in no way be considered as an admission that such prior art is widely known or forms part of common general knowledge in the field.

Telemedicine is a rapidly developing application of clinical medicine where medical information is transferred through the phone or the Internet and sometimes other networks for the purpose of consulting, and sometimes remote medical procedures or examinations.

Telemedicine may be as simple as two health professionals discussing a case over the telephone, or as complex as using satellite technology and videoconferencing equipment to conduct a real-time consultation between medical specialists in two different countries. Telemedicine generally refers to the use of communications and information technologies for the delivery of clinical care.

Care at a distance (also called in absentia care), is an old practice which was often conducted via post. There has been a long and successful history of in absentia health care which, thanks to modern communication technology, has evolved into what we know as modern telemedicine.

The terms e-health and telehealth are at times wrongly interchanged with telemedicine. Like the terms “medicine” and “health care”, telemedicine often refers only to the provision of clinical services while the term telehealth can refer to clinical and non-clinical services such as medical education, administration, and research.

Telemedicine can be broken into three main categories: store-and-forward, remote monitoring and interactive services.

Store-and-forward telemedicine involves acquiring medical data (like medical images, biosignals etc) and then transmitting this data to a doctor or medical specialist at a convenient time for assessment offline. It does not require the presence of both parties at the same time. Dermatology (cf: teledermatology), radiology, and pathology are common specialties that are conducive to asynchronous telemedicine.

A properly structured Medical Record preferably in electronic form should be a component of this transfer. A key difference between traditional in-person patient meetings and telemedicine encounters is the omission of an actual physical examination and history. The store-and-forward process requires the clinician to rely on a history report and audio/video information in lieu of a physical examination.

Remote monitoring, also known as self-monitoring/testing, enables medical professionals to monitor a patient remotely using various technological devices. This method is primarily used for managing chronic diseases or specific conditions, such as heart disease, diabetes mellitus, or asthma. These services can provide comparable health outcomes to traditional in-person patient encounters, supply greater satisfaction to patients, and may be cost-effective.

Interactive telemedicine services provide real-time interactions between patient and provider, to include phone conversations, online communication and home visits. Many activities such as history review, physical examination, psychiatric evaluations and ophthalmology assessments can be conducted comparably to those done in traditional face-to-face visits. In addition, “clinician-interactive” telemedicine services may be less costly than in-person clinical visits.

Telemedicine is most beneficial for populations living in isolated communities and remote regions and is currently being applied in virtually all medical domains. Specialties that use telemedicine often use a “tele-” prefix; for example, telemedicine as applied by radiologists is called Teleradiology. Similarly telemedicine as applied by cardiologists is termed as telecardiology, etc.

Telemedicine is also useful as a communication tool between a general practitioner and a specialist available at a remote location.

The first interactive Telemedicine system, operating over standard telephone lines, for remotely diagnosing and treating patients requiring cardiac resuscitation (defibrillation) was developed and marketed by MedPhone Corporation in 1989. A year latter the company introduced a mobile cellular version, the MDphone.

A new way of practicing telemedicine is emerging better known as Primary Remote Diagnostic Visits whereby a doctor uses devices to remotely examine and treat a patient.

Telehealth is an expansion of telemedicine, and unlike telemedicine (which more narrowly focuses on the curative aspect) it encompasses preventive, promotive and curative aspects. Originally used to describe administrative or educational functions related to telemedicine, today telehealth stresses a myriad of technology solutions. For example, physicians use email to communicate with patients, order drug prescriptions and provide other health services.

Clinical uses of telehealth technologies include: Transmission of medical images for diagnosis (often referred to as store and forward telehealth), Groups or individuals exchanging health services or education live via videoconference (real-time telehealth), Transmission of medical data for diagnosis or disease management (sometimes referred to as remote monitoring), Advice on prevention of diseases and promotion of good health by patient monitoring and follow-up.

In store-and-forward telehealth, digital images, video, audio and clinical data are captured and “stored” on the client computer; then at a convenient time transmitted securely (“forwarded”) to a clinic at another location where they are studied by relevant specialists. The opinion of the specialist is then transmitted back. Based on the requirements of the participating healthcare entities, this roundtrip could take between 2 to 48 hours. In many store-and-forward specialties, such as teleradiology, an immediate response is not critical. Dermatology, radiology and pathology are common specialties that are conducive to store-and-forward technologies.

In real-time telehealth, a telecommunications link allows instantaneous interaction. Videoconferencing equipment is one of the most common forms of synchronous telemedicine. Peripheral devices can also be attached to computers or the video-conferencing equipment which can aid in an interactive examination. With the availability of better and cheaper communication channels, direct two-way audio and video streaming between centers through computers is leading to lower costs.

Examples of real-time clinical telehealth include: Telemental Health—the use of videoconferencing technology to connect a psychiatrist with a mental health client Telerehabilitation Telecardiology Teleneurology Telenursing Teleradiology Teledentistry.

Videoconferencing is a very useful technology for telemedicine and telenursing applications, such as diagnosis, consulting, transmission of medical images, etc., in real time in countries where this is legal. Using VTC, patients may contact nurses and physicians in emergency or routine situations, physicians and other paramedical professionals can discuss cases across large distances. Rural areas can use this technology for diagnostic purposes, thus saving lives and making more efficient use of healthcare funding.

Special peripherals such as microscopes fitted with digital cameras, videoendoscopes, medical ultrasound imaging devices, otoscopes, etc., can be used in conjunction with VTC equipment to transmit data about a patient.

Telepresence refers to a set of technologies which allow a person to feel as if they were present, to give the appearance that they were present, or to have an effect, at a location other than their true location.

Telepresence requires that the senses of the user, or users, be provided with such stimuli as to give the feeling of being in that other location. Additionally, the user(s) may be given the ability to affect the remote location. In this case, the user's position, movements, actions, voice, etc. may be sensed, transmitted and duplicated in the remote location to bring about this effect. Therefore information may be traveling in both directions between the user and the remote location.

Telepresence videotelephony is a higher level of videoconferencing, deploying greater technical sophistication and improved fidelity of both video and audio. An example of which is provided by a major manufacturer of these technologies Cisco Systems TelePresence a commercial product that helps people meet, share content, create high-quality video recordings and events, consult with experts and deliver powerful personalized services, all using the power of the network for an immersive in-person experience.

Providing skilled care to patients in their home has long been an integral part of healthcare in the United States. In the last decade, home care has become even more prominent due to an ageing population, economic pressures, and patient preference. The demand for home healthcare services in the U.S. has increased 20% per year for the last ten years and is expected to continue at this rate. Approximately 7.6 million Americans currently receive home care because of acute illness, long-term health conditions, permanent disability, or terminal illness.

This increased demand for home care has inevitably led to a large increase in home care spending. In 2007, annual expenditures for home healthcare were projected to be $57.6 billion. Medicare is the largest single payer of home healthcare services and, in 2006, its spending accounted for approximately 37% of home health expenditures.

Medicare's home health spending was anticipated to grow 13.7% in 2007, with an average a 10.2% growth rate per year from 2008 to 2017.

In 2001, The Centers for Medicare and Medicaid Services (CMS) implemented a Prospective Payment System (PPS) for Medicare home health, which set a national payment rate and enticed providers to deliver more efficient care. The implementation of the PPS led to a number of challenges for the home care industry, including more accountability for patient improvement regardless of the patient's conditions and reimbursement limitations that significantly impacted the total visits on which home care nurses have to achieve positive results. At the same time, home care agencies have been facing nurse shortages, greater regulations, and more complex care regimens.

According to a recent national survey of almost 1,000 home care agencies, only 17.1% reported that they presently use a telehealth system. A full 88.6% of these agencies reported that telehealth improved the overall quality of services provided to their patients. Specifically, 76.6% reported a reduction in unplanned hospitalizations and 77.2% reported a reduction in emergency room visits. Furthermore, 42.8% of agencies reported that their telehealth program has led to a reduction in cost.

The impending nursing shortage nationwide will affect the delivery of usual home care services as well. Add to the mix an increasing number of patients discharged earlier to home care, owing to hospital-based PPS and its bent toward reduced lengths of stay, (LOS).

In the United States we have many challenges ahead for our healthcare system highlighted by: The Patient Protection and Affordable Care Act (PPACA) a federal statute that was signed into United States law by President Barack Obama on Mar. 23, 2010. This act and the Health Care and Education Reconciliation Act of 2010 (signed into law on Mar. 30, 2010) made up the health care reform of 2010. The laws focus on reform of the private health insurance market, provide better coverage for those with pre-existing conditions, improve prescription drug coverage in Medicare and extend the life of the Medicare Trust fund by at least 12 years.

A major challenge for the government of the United States and the healthcare industry is to overcome the limitations of the healthcare system when it comes to rural and remote areas of the United States.

There are significant barriers to rural healthcare in that there are very few healthcare services or access to Medical Doctors especially when it comes to a specialist in many instances a patient would have to drive for hours from their rural home to an urban area to receive adequate treatment. The lack of ubiquitous broadband internet in these areas also impedes the ability to offer healthcare services especially telemedicine/health.

A general practitioner or GP is a medical practitioner who provides primary care and specializes in nothing and sees everything. A general practitioner treats acute and chronic illnesses and provides preventive care and health education for all ages and both sexes. They have particular skills in treating people with multiple health issues and comorbidities.

The general practice concept has always been based on creating a physician who can “do anything” that may be necessary for the patient's life and welfare, as well as for the community. The general practice movement promotes the continuing education of its doctors using the Internet-based information systems, community-based educational resources as well as academic center based resources.

Medical Doctor specialist's work in many disciplines to provide specific care to patients with acute illnesses.

There is currently a shortage of primary care physicians and also other primary care providers due to several factors, notably the lesser prestige associated with the specialty, the lesser pay, and the increasingly frustrating practice environment. In the US physicians are increasingly forced to do more administrative work, and shoulder higher malpractice premiums. If this continues unabated we can be sure that we will not have enough general practitioners to take care of the majority of healthcare needs. The problem is aggravated by the fact that we also are in a nursing shortage and with approximately 30 million newly insured healthcare consumers the system may not be able to absorb the influx of new patients.

A clinical nurse specialist (CNS) is an advanced practice nurse, with graduate preparation (earned master's or doctorate) from a program that prepares CNSs. CNSs are clinical experts in the diagnosis and treatment of illness, and the delivery of evidence-based nursing interventions. CNSs work with other nurses to advance their nursing practices and improve outcomes, and provide clinical expertise to effect system-wide changes to improve programs of care. The three domains of CNS practice, known as the three “spheres of influence” are the patient/family, nursing personnel and system/network organization.

The three spheres are overlapping and interrelated, but each sphere possesses a distinctive focus. In each of the spheres of influence, the primary goal of the CNS is continuous improvement of patient outcomes and nursing care.

Within the three domains of CNS practice there are seven core competencies which are:

1. Direct clinical practice includes expertise in advanced assessment, implementing nursing care, and evaluating outcomes. 2. Expert coaching and guidance encompasses modeling clinical expertise while helping nurses integrate new evidence into practice. It also means providing education or teaching skills to patients and family. 3. Collaboration focuses on multidisciplinary team building. 4. Consultation involves reviewing alternative approaches and implementing planned change. 5. Research involves interpreting and using research, evaluating practice, and collaborating in research. 6. Clinical and professional leadership involves responsibility for innovation and change in the patient care system. 7. Ethical decision-making involves influence in negotiating moral dilemmas, allocating resources, directing patient care and access to care.

Historically, in North America, the CNS role developed within the acute care (hospital) setting. Currently, in addition to the traditional acute care setting, CNS practice in a variety of non-acute care settings. No matter what the setting is, CNS are a valuable resource for staff development as an expert clinician as well as a resource to organizations and systems in improving quality and conserving resources.

A Nurse Practitioner (NP) is a registered nurse who has completed specific advanced nursing education (generally a master's degree or doctoral degree) and training in the diagnosis and management of common as well as a few complex medical conditions.

Nurse Practitioners provide a broad range of healthcare services. Nurse Practitioners treat both physical and mental conditions through comprehensive history taking, physical exams, physical therapy, ordering tests and therapies for patients, within their scope of practice. NPs can serve as a patient's “point of entry” health care provider, and see patients of all ages depending on their designated scope of practice.

NP's prescribe physical therapy and other rehabilitation treatments Prescribing drugs for acute and chronic illness (extent of prescriptive authority varies by state regulations) Providing prenatal care and family planning services providing well-child care, including screening and immunizations Providing primary and specialty care services, health-maintenance care for adults, including annual physicals. Providing care for patients in acute and critical care settings Assisting in minor surgeries and procedures (with additional training and usually under supervision) (e.g., dermatological biopsies, suturing, casting) Counseling and educating patients on health behaviors, self-care skills, and treatment options

NPs practice in all U.S. states. The institutions in which they work may include, but are not limited to, the following: Community clinics, health centers, urgent care centers etc.

To be licensed as a nurse practitioner, the candidate must first complete the education and training necessary to be a registered nurse (RN).

A Registered Nurse (RN) is a health care professional responsible for implementing the practice of nursing through the use of the nursing process in conjunction with other health care professionals. Registered Nurses work as patient advocates for the care and recovery of the sick and maintenance of their health. In their work as advocates for the patient, RNs use the nursing process to assess, plan, implement, and evaluate nursing care of the sick and injured. RN's have a significantly expanded scope of practice, education and clinical training compared to that of licensed practical nurses.

Among the many cited causes for the nursing shortage is the lack of qualified doctoral or master degree prepared faculty for college RN programs. Students cannot be admitted to school if there is no faculty to teach them. Furthermore, there is evidence that faculty positions for RN programs do not command equivalent salaries to those of their peers in other fields.

Pub. NO.: US 2003/0031992 A1

A technique is provided for collaboratively training, servicing, managing and interacting with a remote computing system and persons associated with a medical diagnostic imaging system. Screen data is captured, transmitted and cached between a plurality of remote computing systems and persons to facilitate shared computing for medical environments.

Pub. No.: US 2006/0052676 A1

A system that includes a mobile platform and a remote station. The remote station may be a personal computer coupled to the remote platform through a broadband network. A user can control movement of the mobile platform through the remote station. A medical monitoring device such as a stethoscope or EKG monitor can be coupled to the mobile platform and used to take patient data. The data can be transmitted to the remote station by the mobile platform. The medical monitoring devices may be wirelessly coupled to the mobile platform. The system may include a server that can provide an electronic medical record and a image captured by a camera of the mobile platform. The system allows a doctor at the remote station to more fully examine a patient while viewing past medical records.

Pub. No.: US 2006/0074722 A1

A method and system for providing medical service. A measured data of a patient is transmitted to a database; and the measured data is retrieved from the database by the selected physician so that the physician can perform a diagnosis based on the measured data.

U.S. Pat. No. 7,432,949

A mobile self-powered videoimaging, video communication, video production (VCVP) system designed specifically for healthcare industry that provides high-resolution audio, video and data communications, production and recording capabilities at hospital operating room/procedure room or field environment for transmission to other remote locations. The VCVP system generally comprises a mobile platform with a plurality of cameras, at least one being mounted on an extensible boom for overhead imaging or surgical procedures. An array of video production equipment is rack-mounted inside the platform, as is an array of network teleconferencing equipment. The mobile imaging system maybe parked at a convenient location in an operating room or other high resolution video/audio feed that is networked in real time for teleconferencing, and/or recorded to a hard drive or in any known format such as Mini-DV, S-VHS, VHS and DVD as desired.

U.S. Pat. No. 7,640,271

A portable health care records system employs a server in which the health care records of participating patients are stored. The patients may access the system using cards or CD-ROMS that are inserted into the patients computer. The patients can review their own records via internet and can edit them. The patient may also access via cell phone or hand held device. The patient record is protected by patient ID and password. Treating physicians have access to each patients records for review and update. A two-way firewall permits patients to send patient to review their own health records only, but permits the physician to review both the physician files and the patients files. The physician can override the firewall to send patient information from his or her record. A read-only emergency screen with medical data about the patient may be accessed for emergency use. Records of many patients and of many clinics are maintained on a common server, so the patient record can be accessed globally.

Pub. No.; US 2009/0009615 A1

The invention is a medical platform system that overcomes many of the shortcomings of current systems. The novel platform provides simultaneous image display and capture, network based wireless control, preferably by way of web browser, and the capacity to acquire surgeon specific setting by way of removable storage devices

Pub. No.; US 2009/0292552 A1

An integrated and interactive health-management system allows a medical-care recipient to transmit both physiological and non-physiological information obtained through his/her self-monitoring to a medical-service platform so that related medical treatment can learn the medical-care-recipients home care status and provide the medical- care-recipient with professional suggestions and assistance accordingly.

Pub. No.; US 2009/0287504 A1

A method for providing an imaging study at a client terminal. The method comprises receiving a request for an imaging study from a client terminal connected to a first system of a plurality of medical imaging systems and identifying a destination of a device hosting the requested imaging study. The device is disparately connected to a second system of the plurality of medical imaging systems. The method further comprises acquiring the imaging study from the hosting device using the destination and forwarding the imaging study to the client terminal.

U.S. Pat. No. 7,691,059

A method for providing a covering physician service includes informing a patient of a practicing physician of the availability of the plurality of patient terminals and referring the patient to one or the patient terminals upon the agreement of the patient. A call from the patient at the patient terminal is received at a call center. The call center enables any of a first plurality of physicians (or other healthcare practitioner) terminals to be in audio-visual communication over the network with any of a second plurality of patient terminals. The call is routed to an available physician or other healthcare practitioner at one of the health care practitioner terminals so that the available physician may carry on a two-way conversation with the patient and visually observe the patient. The available physician or health care practitioner is permitted to make an assessment of the patient and to treat the patient.

U.S. Pat. No. 7,698,153

An information collection and processing system and related automated method for use by an organization providing health care to a given population. The system includes an arrangement for storing information relating to a plurality of contractual relationships existing between the organization, a plurality of health care providers, and a plurality of payors. The storage arrangement also includes information relating to a plurality of patients in the given population, and information relating to transactions between the organization, providers and payors. An aspect of the system and method relates to storing information relating to an expected receivable resulting from an encounter between a patient and one or more of the providers, storing information relating to a corresponding remittance received as a result of said encounter, comparing the expected receivables with the corresponding remittances, and initiating an action if the remittance falls outside of the predetermined limits of the respective receivable.

U.S. Pat. No. 7,307,543

A system and method for observing patients in geographically dispersed health care locations. A patient is assigned to a health care location comprising a patient visual monitoring system, a patient audio receiver, and a patient controller. The visual monitoring system is responsive tri-axially to command signals received via a patient controller connected to a network. The patient controller sends patient imaging data and patient audio data to a remote command center via the network. A computerized patient care management system comprising the remote command center monitors patient data, patient imaging data, and patient audio data determines from the patient data, the patient imaging data, and the patient audio data if intervention with the selected patient is warranted.

U.S. Pat. No. 7,411,509

A system and method for observing patients in geographically dispersed health care locations. A portable monitoring station is associated with a patient assigned to a health care location. The portable monitoring station comprises monitoring equipment that monitors physiological measures of the patient. A remote command center receives the monitored data elements, accesses patient data elements indicative of a medical condition associated with the patient, and applies a patient-specific rule to selected data elements to determine whether the patient-specific rule has been contravened. The monitored equipment may further comprise video and audio equipment that captures patient video data and provides these data to the central command center.

U.S. Pat. No. 7,650,291

A video visitation system and method for dispersed health care locations. A patient data server, a teleconferencing server, a patient visual monitoring system and a visitor visual monitoring system are connected to a network. A patient data server receives patient data indicative of the condition of a patient and serves the patient data continuously and in real time to the teleconferencing server. The patient visual monitoring system acquires patient imaging data from a patient location and conveys that patient imaging data to the teleconferencing server. The patient visual monitoring system displays the visitor imaging data and the visitor visual monitoring system simultaneously displays patient imaging data and the continuous real time feed of the patient data.

U.S. Pat. No. 7,730,177

A system for remotely monitoring an individual. The system includes a server system for generating a script program from a set of queries. The script program is executable by a remote apparatus that displays information and/or a set of queries to the individual through a user interface. Responses to the queries that are entered through the user interface together with individual identification information are sent from a remote apparatus to the server system across a communication network. The server system also includes an automated answering service for providing a series of questions from a stored set of questions for an individual at the remote apparatus to respond to, storing responses to each provided question in the series of questions and providing a service based on the individuals response to the questions.

U.S. Pat. No. 7,734,656

A method for conducting genetic research on medical data. The method includes the step of accessing a database storing a plurality of medical records associated with a plurality of individuals, each medical record including at least one unique identifier associated with a certain individual. The method also includes the steps of extracting from the database the medical data associated with the respective unique identifier. Also, the method includes processing the extracted medical data and obtained genetic data for attempting to identify an association between particular genetic data and a particular medical condition.

Pub. No.; US 2010/0145723 A1

A user device for connecting symptom, disease, procedure, and facility based information into actionable services for medical care and cost analysis is presented. The user device may include the functionality of linking medical information and providing user specific information. The user specific information allows the user to make an informed decision about medical treatment. The user device may further be operative to tailor information in light of user characteristics such as location or healthcare network membership.

Pub. No.; US 2010/0287001 A1

The presently disclosed digital healthcare platform provides patients and healthcare providers with a precise and focused treatment pathway to address healthcare issues. One embodiment enables a patient-initiated e-visit to address a healthcare issue with an issue-focused adaptive interview. The results of this adaptive interview are forwarded to a skilled clinician for review, who then provides an assessment and a plan of action for the issue. The plan of action may include specific instructions, a prescription, or a referral to a third party medical provider for testing, consultation, or treatment. Another embodiment provides an identification “ticket” to the patient to coordinate care obtained at third parties. The ticket can be presented by the patient to a third party medical provider (such as with a barcode display on a mobile device) to identify the patient and enable the third party medical provider to access patient information from the digital healthcare platform.

An ambulance is a vehicle for pre-hospital treatment and transportation of sick or injured people, to, from or between places of treatment for an illness or injury. The term ambulance is used to describe a vehicle used to bring medical care to patients outside of the hospital or to transport the patient to hospital for follow-up care and further testing. The word is most commonly associated with the land-based, emergency motor vehicles that administer emergency care to those with acute illnesses or injuries, hereafter known as emergency ambulances. These are usually fitted with flashing warning lights and sirens to facilitate their movement through traffic.

There are other types of ambulance, with the most common being the patient transport ambulance. These vehicles are not usually (although there are exceptions) equipped with life-support equipment, and are usually crewed by staff with fewer qualifications than the crew of emergency ambulances. Their purpose is simply to transport patients to, from or between places of treatment.

The prior art does not combine a control center with remote Medical Doctors directing onsite Nurses practicing from a network of mobile medical platforms equipped with state of the art medical diagnostic, treatment, telemedicine/health, satellite, communication, computing, clean energy technologies and related patient services such as prescription medication, insurance billing and healthcare follow up procedures into one coherent method and system that provides concierge medical services to healthcare patients at their point of need regardless of geographic location.

The method and system will also reduce the costs of healthcare services thru the control center and network of mobile medical platforms automated systems of patient care/treatment and service procedures.

### BRIEF SUMMARY OF THE INVENTION

The method and system provides concierge medical services through the use of a control center and a network of mobile medical platforms equipped with state of the art medical diagnostic and treatment tools, digital devices, telemedicine/health, satellite, communication, computing and clean energy technologies used by remote Medical Doctors and onsite Nurses to physically examine and treat patients regardless of the patients location. The method and system can be used in remote, rural or urban settings to provide greater access to and less expensive healthcare services.

### BRIEF DESCRIPTION OF DRAWINGS

The drawings are a flowchart that describe the uses of the control center and a network of mobile medical platforms of this method and system.

The method and system covers a patient using digital devices and the internet to access the systems control center to register for healthcare services.

The control center takes the patient through the process to schedule a medical appointment and for a networked mobile medical platform to be assigned for the visit.

The patient will have a hand's on examination performed by the onsite medical professional working in the network of mobile medical platforms who is being directed remotely by a Medical Doctor.

The control center and network of mobile medical platform systems provide for follow up procedures for the patient including tests, prescriptions and perhaps more doctor visits.

The control center processes the patient's information, records the visit and outcomes in their electronic health record and bills the insurance company.

The patient can use the system for their continued healthcare needs.

### DETAILED DESCRIPTION OF THE INVENTION

The method and system is a control center and a network of mobile medical platforms staffed with medical professional's onsite and remotely who employ state of the art medical, communication/computing and clean energy technologies to provide and deliver concierge medical services to patients at their point of need.

Using a network enabled digital device a patient accesses the control center via the internet or a call center to register to be a member of the healthcare service.

The patient provides their personal, healthcare and insurance information to the control center of the networked mobile medical platforms.

The patient is provided with a member account and their personal electronic health record.

The patient uses the control center of the network of mobile medical platforms to schedule an appointment to see a Medical Doctor.

The patient provides background information about their healthcare needs thru questionnaires on the websites or directly thru the control center.

The patient is then assigned by the control center to a Medical Doctor and an appointment is made for their visit to one of the network of mobile medical platforms.

A copy of the appointment information is sent to the patient's digital devices.

The control center assigns a networked mobile medical platform to go to the patients preferred location such as a remote, rural or urban area, business, school, home etc.

The network mobile medical platform arrives at the location and admits the patient. The patient is greeted given an explanation of how everything works in the networked mobile medical platform.

The patient is examined by the onsite medical personnel and the vital information is forwarded from the network of mobile medical platforms to the remote Medical Doctor assigned to the patient thru the control center.

The remote Medical Doctor uses the network of mobile medical platforms, videoconferencing and diagnostic systems to direct the onsite medical professional stationed in the network of mobile medical platforms on how to examine the patient.

The remote Medical Doctor then diagnoses the patient's medical needs and creates a treatment plan which may include testing, specialists, prescriptions and other follow up procedures. The patient's data that was gathered in the examination is added to the patient's electronic health record.

The control center bills the patient's insurance company.

The patient can remain an active member of their healthcare team thru the control center functions.

The network of mobile medical platforms are equipped with green energy technologies such as flex fuels and solar to power the platforms.

The first embodiment of the method and system pertains to patients in remote and rural environments that can use the control center and network of mobile medical platforms to access healthcare services at their point of need.

The second embodiment of the invention relates to both remote/rural and urban environments where the control center and the network of mobile medical platforms are used to provide group medical examinations and follow-up using the above mentioned system and technologies.

In this iteration a group of localized patients would make appointments thru the control center to see a doctor. The visits would be coordinated thru the control center, assigned to a networked mobile medical platform and brought to the group of patient s place of need such as a business, office building, university, school, senior citizens home, apartment building, Social Security, Medicaid office locations etc. to provide health care services to a group of patients at the same location.

Another embodiment enables the network of mobile medical platforms to be used in emergency situations although they are not emergency vehicles such as an ambulance is the network of mobile medical platforms could assist in extreme cases such as natural disasters where they would if necessary provide medical assistance.

The system and method enables high quality concierge medical services to be delivered to the patient's point of need at a reduced cost while providing patients with greater access to the healthcare system.

These are the main embodiments but they are not the only way to use the method and system of a control center and network of mobile medical platforms.

### CONCLUSION, RAMIFICATION AND SCOPE

In the United States we are approaching a severe shortage of Medical Doctors and Nurses especially in the general practice medical field. It is taking longer and longer for a patient to get an appointment to see a general practitioner, specialist or their own primary care doctor if they can find one to take them as a patient at all.

Now with The Patient Protection and Affordable Care Act (PPACA) of 2010 and the millions of newly insured healthcare consumers it creates it will be much harder.

What is not adequately addressed in the bill is the lack of Medical Doctors, Nurses and treatment facilities to serve the approximately 30 million new patients that will now have health insurance many for the first time. The wait time to see a Medical Doctor will force more of the newly insured into hospital emergency rooms which carry the highest costs for healthcare services.

Using the method and system of a control center and a network of mobile medical platforms employing onsite medical professionals such as Nurses and remote Medical Doctors using advanced medical diagnostic, teleconferencing, satellite, communication, computer, electronic health records, digital devices and clean energy technologies to treat patients at the patients choice of location and appointment time creates a hereto unknown medical service.

The method and system enables cost savings in the healthcare field including the patient's time and expense normally spent going to and from a doctor's office and the actual cost of the healthcare service that is reduced through the automation processes of the control center and network of mobile medical platforms.

The method and system using advanced technologies such as electronic health records can reduce unnecessary medical procedures and testing which will reduce healthcare costs.

Using the method and system medical malpractice costs can be reduced through the use of the control center and the network of mobile medical platforms video and audio recording of patient visits.

The method and system combines onsite and remote medical professionals, a control center and a technology laden network of mobile medical platforms that work together to provide a healthcare service that affords greater patient access to medical services at a reduced cost and creates a hereto unknown source of medical facilities and patient services.

I claim:

1. A method and system comprised of a control center and a network of mobile medical platforms to provide a complete healthcare system

2. A method and system that uses a control center to aggregate medical professionals, diagnostic equipment, the internet, digital devices, video conferencing, software, computing, communication and clean energy technologies with a network of mobile medical platforms to service patients healthcare needs

3. A control center that coordinates a network of mobile medical platforms to serve health care consumers needs

4. A method and system using digital devices, computing, communication and internet to schedule patient visits thru a control center and network of mobile medical platforms

5. A method and system to create and maintain electronic healthcare records for patients via the control center and network of mobile medical platforms

6. A control center and network of mobile medical platforms that employ onsite medical professionals to staff, examine and treat patients healthcare needs

7. A control center and network of mobile medical platforms that employ a remote Medical Doctor using video conferencing technologies and telemedicine processes to direct local medical professionals stationed in mobile medical platforms to perform hands on examinations and testing of patients

8. A control center and a network of mobile medical platforms that provide concierge medical services to patients at the point of need such as remote, rural and urban environments where the network of mobile medical platforms go to the patients location such as schools, homes, businesses, Medicaid offices etc.

9. A method and system using a control center and network of mobile medical platforms to treat home bound patients

10. A control center and network of mobile medical platforms that enable group patient scheduling and delivery of concierge medical services

11. A method and system to provide preventative medical services thru the use of a control center, medical professionals and a network of mobile medical platforms, digital devices and the internet

12. A method and system using a control center and network of mobile medical platforms to provide a prescription drug service

13. A method and system using a control center and network of mobile medical platforms to facilitate the patient's medical payment services, insurance and billing

14. A control center and a network of mobile medical platforms that use satellite technologies to provide broadband internet access to the mobile medical platforms and control center for healthcare services in remote and or rural areas

15. A mobile medical platform employing clean energy technologies to produce electric power for the mobile medical platforms and other designated equipment
